(19) United States
(12) Patent Application Publication
(10) Pub. No.: US 2009/0283288 A1
(43) Pub. Date: Nov. 19, 2009

(54) COMMUNICATION CABLE FOR HIGH FREQUENCY DATA TRANSMISSION

(75) Inventor: Jacob BEN-ARY, Kiryat-Bialik (IL)

Correspondence Address: MARTIN D. MOYNIHAN d/b/a PRTSI, INC., P.O. BOX 16446, ARLINGTON, VA, 22215, US

(73) Assignee: Teldor Cables & Systems Ltd., Kibbutz Ein dor- Doar-Na Yizrael (IL)

(21) Appl. No.: 12/511,098

(22) Filed: Jul. 29, 2009

Related U.S. Application Data
(63) Continuation-in-part of application No. PCT/IL2008/000152, filed on Feb. 5, 2008.
(60) Provisional application No. 60/899,891, filed on Feb. 7, 2007.

(51) Int. Cl. H01B 11/06

(52) U.S. Cl. 174/34; 977/773

(57) ABSTRACT

A communication cable for high-frequency data-transmission, includes a core including at least one group of twisted insulated conductors; an inner jacket of insulating polymeric material enclosing the core; and an outer jacket of a conductive polymeric material enclosing the cable core and inner jacket. The outer jacket has a sufficiently high electrical conductivity to substantially reduce electromagnetic interference, but not so high as to require grounding of the cable or to unduly attenuate the signal transmitted by the cable at the high-frequency data-transmission. Preferably, the conductive polymeric material has a resistivity in the range of 1.0×10¹⁰ to 1.0×10¹² Ω·cm, preferably about 1.0×10¹¹ Ω·cm. In two described embodiments, the outer jacket includes a polymeric material loaded with barium-ferrite or carbon black; and in a third described embodiment, the polymeric material of the outer jacket includes metal particles, preferably copper, of nano-meter size

### RELATED APPLICATIONS

The present application is a continuation-in-part of the US National Phase Application of PCT Patent Application No. PCT/IL2008/00152 filed Feb. 5, 2008, which claims the benefit of U.S. Provisional Application No. 60/899,691 filed Feb. 7, 2007, the contents of which are incorporated herein by reference.

### FIELD AND BACKGROUND OF THE INVENTION

The present invention relates to communication cables, and particularly to communication cables for high-frequency data-transmission.

One type of communication cable for high-frequency data-transmission includes a plurality of pairs of twisted insulated conductors. Such communication cables must meet stringent requirements with regard to certain electrical characteristics, such as protection from electromagnetically-generated noise from adjacent conductor pairs (cross-talk) and from adjacent cables and other external sources (alien cross-talk), signal-to-noise ratio, attenuation, etc., and various standards have been adopted setting forth these requirements. Cross-talk in particular presents a problem in high frequency communication cables because it increases sharply with an increase in the frequency of transmission. One method of reducing cross-talk is to provide the cable with electrical shielding in the form of a layer of metal foil or braid, as described, for example, in U.S. Pat. Nos. 5,789,711 and 6,333,465. However, the electrical standards applicable to shielded cables require grounding of the metal shielding layer, which substantially increases the cost of manufacturing the communication cable, as well as the cost for installing and repairing it.

### OBJECTS AND BRIEF SUMMARY OF THE PRESENT INVENTION

A principal object of the present invention is to provide a communication cable for high-frequency data-transmission which meets the electrical standards regarding cross-talk and attenuation, but which does not require grounding of the cable.

This object is achieved by the present invention by providing the communication cable with a jacket of a conductive polymeric material having a sufficiently high electrical conductivity to substantially reduce electromagnetic interference, but not so high as to require grounding of the cable or to unduly attenuate the data transmitted by the cable at the high-frequency of data-transmission.

According to a broad aspect of the present invention, therefore, there is provided a communication cable for high-frequency data-transmission, comprising: a core including at least one group of twisted insulated conductors; an inner jacket of insulating polymeric material enclosing the core; and an outer jacket of a conductive polymeric material enclosing the inner jacket; the outer jacket having an electrical conductivity sufficiently high to substantially reduce electromagnetic interference, but not so high as to require grounding of the cable or to unduly increase the attenuation of the signal transmitted by the cable at the high-frequency of data-transmission.

It has been found that the foregoing results can be achieved when the conductive polymeric material has a resistivity in the range of 1.0×10¹⁰ to 1.0×10¹² Ω·cm, preferably about 1.0×10¹¹ Ω·cm. The term “about” is intended to include ±10%.

In two preferred embodiments of the invention described below, the outer jacket of conductive polymeric material includes a polymeric material sufficiently loaded with barium-ferrite and carbon black, respectively, to have said electrical conductivity.

Preferably, the barium-ferrite or carbon black constitutes from 5% to 45%, more preferably about 20%, by weight of the non-metallic conductive polymeric jacket.

In a third described embodiment, the outer jacket is of a conductive material having a sufficient quantity of metal particles of a nano-meter size to have a sufficiently high electrical conductivity to substantially reduce electromagnetic interference, but not so high as to require grounding of the cable or to unduly attenuate the signal transmitted by the cable at the high rates of data-transmission. Particularly good results were obtained using metal particles of copper of nano-meter size.

It was found that such a communication cable is capable of high data-transmission rates, in the 1-10 Gbs range, with substantially reduced electromagnetic interference and sufficient high signal-to-noise ratio to meet the present standards for such cables with respect to cross-talk, attenuation, etc., but without grounding of the cable as required in the current standards. This result was quite surprising particularly since adding conductive particles, such as barium-ferrite or carbon black, and particularly metal particles such as copper, to a jacketing layer, would be expected to change the dielectric constant of the insulating layer such as to unduly increase the attenuation of the signal transmitted by the cable. It was therefore quite surprising and unexpected to find that conductive particles could be added to the jacketing layer sufficiently to reduce electromagnetic interference and alien cross-talk without unduly increasing attenuation, to meet the current standards for shielded communication cables without the need to ground the cable as also required by the current standards.

It is believed that there are two different mechanisms of action involved when using, on the one hand, non-metallic particles, such as barium-ferrite or carbon black, to render the polymeric material conductive as set forth and, on the other hand, when using metallic particle such as copper of nano-meter size, to render the polymeric material conductive as set forth above.

Thus, when the conductive polymeric material is loaded with non-metal conductive particles, such as barium-ferrite and carbon black, the resulting conductive jacket defines an absorbing shield which stores magnetic energy at the relevant frequency range, e.g. 1-500 MHz, which is stored within the hysteresis loop, and which is turned into heat as a result of electron vibration. On the other hand, when the conductive polymeric material is loaded with metal particles, such as copper, of nano-meter size, the conductive jacket defines an equipotential surface serving as a reflectance shield of electromagnetic energy at the relevant frequency range. Thus, such metals with high conductivity (low resistance) define an equipotential surface such that the reflectance is achieved due to zero interface tension restraint. Since metal particles of nano-meter size present little if any electrical contact between the particles, there is no movement of free electrons. Therefore, the polymeric jacket has the characteristic of full reflectance of the right angled electromagnetic field that meets it.

Further features and advantages of the invention will be apparent from the description below.

### BRIEF DESCRIPTION OF THE DRAWINGS

FIG. 1 illustrates a preferred embodiment of communication cable for high-frequency data-transmission constructed in accordance with the present invention.

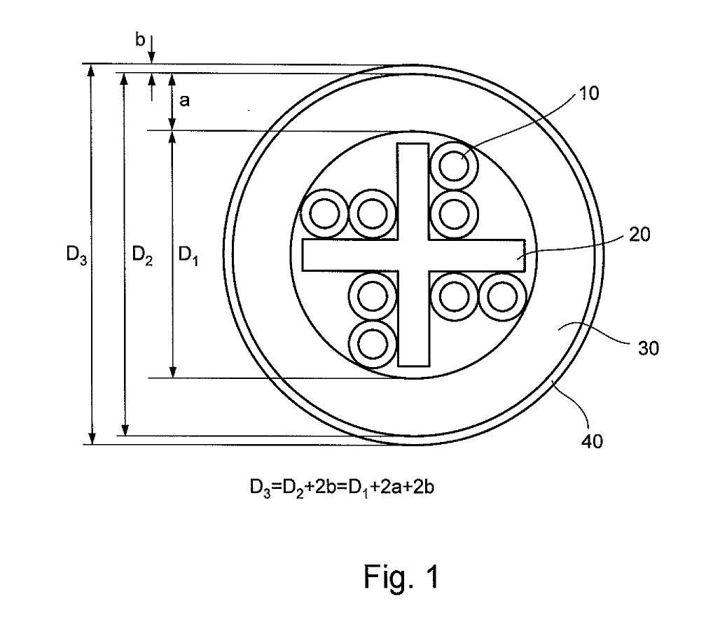

### DESCRIPTION OF THE PREFERRED EMBODIMENT

The accompanying single FIGURE of drawings illustrates one form of communication cable for data-transmission rates, e.g. in the 1-10 Gbs range, constructed in accordance with the present invention. The illustrated cable includes a core comprising four pairs of twisted insulated conductors 10, and a four-sided separator 20 of cruciform cross-section. For example, each pair of twisted insulated conductors 10 is preferably of insulated copper conductive wires 28AWG-20AWG twisted along their lengths so as to be suitable for the transmission of balanced signals. Separator 20 may be of an extruded thermoplastic polymer, preferably polyethylene.

The illustrated cable further includes an inner jacket 30 of an insulating polymeric material enclosing the core. Inner jacket 30 may be extruded over the cable core. It is preferably made of a polymer or copolymer of polyethylene of a thickness for the required insulation and mechanical properties of the cable.

The illustrated cable further includes an outer jacket 40 of a non-metallic conductive polymeric material enclosing inner jacket 30. Outer jacket 40 is preferably made of a polymeric material loaded with electrically-conductive particles, preferably barium-ferrite or carbon black, to have sufficiently high electrical conductivity such as to substantially reduce electromagnetic interference, but not so high as to require grounding of the cable or to unduly attenuate the signal transmitted by the cable at the high data-transmission rates. Outer jacket 40 thus creates a “virtual shield”, or quasi-equipotential shield, that acts as a Faraday cage, enabling the cable to meet the requirements with respect to cross-talk (alien as well as inter-pair cross-talk) and attenuation of the twisted pair cable, without the need for grounding.

Following is one manner for calculating the thicknesses of the insulation of the insulated conductors 10, the insulated spacer 20, the inner jacket 30 of insulating material, and the outer jacket 40 of non-metallic conductive insulating material, to create the above-described shield:

If D₁ is the inner diameter of the cable's inner jacket 30 and D₂ is its outer diameter, then the wall thickness of the inner jacket (a) is calculated as:

$$a = \frac{D 2 - D 1}{2} \qquad ( Eq . 1 )$$

The insulation resistance of the inner jacket RJp (in Ωkm) is calculated as follows by interrelating the wall thickness a, Rm and Ku, where Rm is the specific resistance of the insulation material, and Ku is a unit conversion constant:

$$RJp = Rm \frac{ln ( \frac{D 2}{D 1} )}{Ku} \qquad ( Eq . 2 )$$

Adding the outer jacket 40 of a thickness b over the inner jacket 30 increases the overall diameter D₃ as shown below:

D3=D2+2b=D1+2a+2b (Eq.3)

If the additional outer layer has a specific resistance Rma (Ωkm), then the total insulation resistance RJ (Ωkm) can be calculated as follows:

$$RJ = RJp + Rma \frac{ln ( \frac{D 3}{D 2} )}{Ku} \qquad ( Eq . 4 )$$

The minimum value of the total insulation resistance RJ is defined in the appropriate International, Regional or National cable standards to be implemented.

### EXAMPLES

Following are examples of one construction of a high-frequency data-transmission communication cable in accordance with the present invention, with the relative insulation thicknesses being determined as described above, for a Category 6_{A} U/UTP (Unshielded Twisted Pair) cable with pair separator for use in a 10 GBASE-T system:

In one example, the insulation in each of the pair of twisted insulated conductors 10 may be of Polyethylene having the following characteristics: Borealis 3363 Dielectric constant@1 MHz 2.30, dissipation factor@1 MHz 0.00015, DC volume resistivity 10¹⁶ Ω·cm and diameter of 1.08 mm; over which there may be an additional layer of Linear low density polyethylene Borealis 8706, dielectric constant@1 MHz 2.33, dissipation factor@1 MHz 0.00006, DC volume resistivity 1016 Ω·cm, overall outer diameter 1.09±0.01 mm, capacitance 222±3 pF/m, and DC resistance 57.85±0.35 Ω/km.

Separator 20 is a cross-shaped pair separator of linear low density polyethylene Borealis 8706, dielectric constant@1 MHz 2.33, dissipation factor@1 MHz 0.00006, DC volume resistivity 10¹⁶ Ω·cm, outer dimension 4.6 mm nom, and fin thickness 0.6 mm nom.

The inner jacket 30 of insulating polymeric material is of polyethylene based halogen free flame retardant compound Borealis FR4804, dielectric constant 2.89, wall thickness 1.35 mm nom, and outer diameter 8.0 mm nom.

The outer jacket 40 of non-metallic conductive polymeric material is a blend of a non-metallic barium-ferrite powder, manufactured by Strontium Ferriten India 0.25±0.05 MGOe and average particle size 3.00±0.50 μm, with a sulphonated polymer, DuPont “Hypalon® (H-45”, surface resisitivity 1000Ω, wall thickness 0.10 mm nom, and overall cable outer diameter 8.20±0.1 mm.

Following is one example of calculating the various wall thicknesses to produce such a Category 6_{A} U/UTP cable with pair separator for use in a 10 GBASE-T system.

Thus, if D₁ is 5.3 mm and D₂ is 8.0 mm, the wall thickness of the inner jacket (a) is 1.35 mm. This wall thickness of 1.35 mm is used for calculating the insulation resistance of inner jacket RJp. By adding the outer jacket 40 of a thickness of 0.10 mm over the inner jacket 30, the overall diameter of the cable as increased by the outer jacket will be 8.30 mm.

The total insulation resistance RJ may then be calculated using equation 4. The minimum value of the total insulation resistance RJ is defined in cabling standards.

In a second example, the outer jacket is also of a non-metallic conductive polymeric material but includes carbon powder, rather than barium-ferrite powder. Otherwise, the construction is substantially the same as described above.

In a further example, the outer jacket 40 includes metal particles, rather than non-metal particles, blended with the polymeric material. Particularly good results were obtained when the metal particles were particles of copper of nano-meter size homogenously mixed with the polymeric material to produce a resistivity in the range of 1.0×10¹⁰ to 1.0×10¹² Ω·cm, and preferably of about 1.0×10¹¹ Ω·cm. When using copper nano-particles, preferably the overall polymeric composition should include 0.1 to 3.0% copper by weight, and more preferably about 1.0% copper by weight. As indicated earlier, the term “about” is intended to cover ±10%.

While the invention has been described with respect to several preferred embodiments, it will appreciated that these are set forth merely for purposes of example, and that many variations may be made. For example, the invention could be implemented in a communication cable having other constructions of the core, rather than the four pairs of twisted conductors as illustrated in the drawing. In addition, the cable could include other intervening layers between the inner jacket and the core, other intervening layers between the inner jacket and the outer jacket, and/or other layers over the outer jacket. Further, other materials could be used for the insulation and for the electrically-conductive particles than those described above. The invention could also be implemented with only one outer jacket over the cable core.

Many other variations, modifications and applications of the invention will be apparent.

What is claimed is:

1. A communication cable for high-frequency data-transmission, comprising: a core including at least one group of twisted insulated conductors; an inner jacket of insulating polymeric material enclosing said core; and an outer jacket of a conductive polymeric material enclosing the inner jacket; said outer jacket having an electrical conductivity sufficiently high to substantially reduce electromagnetic interference, but not so high as to require grounding of the cable or to unduly attenuate the signal transmitted by the cable at the high-frequency data-transmission.

2. The communication cable according to claim 1, wherein said conductive polymeric material is loaded with non-metal conductive particles to define an absorbing shield which stores magnetic energy at the relevant frequency range and turns it into heat as a result of electron vibration.

3. The communication cable according to claim 2, wherein said conductive polymeric material has a resistivity of 1.0×10 to 1.0×10¹² Ω·cm.

4. The communication cable according to claim 2, wherein said conductive polymeric material has a resistivity of about 1.0×10¹¹ Ω·cm.

5. The communication cable according to claim 4, wherein said outer jacket includes a polymeric material loaded with barium-ferrite or carbon black to have said electrical conductivity.

6. The communication cable according to claim 4, wherein said barium-ferrite or carbon black constitutes from 5% to 45% by weight of said outer jacket.

7. The communication cable according to claim 5, wherein said barium-ferrite or carbon black constitutes about 20% by weight of said outer jacket.

8. The communication cable according to claim 1, wherein said conductive polymeric material is loaded with metal particles of nano-meter size to define an equipotential surface serving as a reflectance shield of electromagnetic energy at the relevant frequency range.

9. The communication cable according to claim 8, wherein said conductive polymeric material has a resistivity in the range of 1.0×10¹⁰ to 1.0×10¹² Ω·cm.

10. The communication cable according to claim 8, wherein said conductive polymeric material has a resistivity of about 1.0×10¹¹ Ω·cm.

11. The communication cable according to claim 8, wherein said metal particles of nano-meter size are of copper.

12. The communication cable according to claim 8, wherein said copper of nano-particle size constitutes 0.1-3.0% by weight of the conductive polymeric material.

13. The communication cable according to claim 8, wherein said of nano-particle size constitutes about 1.0% by weight of the conductive polymeric material.

14. The communication cable according to claim 1, wherein said polymeric material of said outer jacket is or includes chlorosulphonated polyethylene.

15. The communication cable according to claim 1, wherein the wall thickness of said outer jacket of conductive polymeric material is from 0.050 mm to 3.0 mm.

16. The communication cable according to claim 1, wherein the wall thickness of said outer jacket of conductive polymeric material is from 0.10 mm to 0.20 mm.

17. The communication cable according to claim 1, wherein said core includes four pairs of twisted insulated conductors separated by a four-sided separator of insulating material.

18. The communication cable according to claim 17, wherein said separator is composed of or includes polyethylene.
